(19) United States
(12) Patent Application Publication
(10) Pub. No.: US 2025/0058974 A1
(43) Pub. Date: Feb. 20, 2025

(54) PORTABLE LOAD DISTRIBUTING CARRYING APPARATUS

(71) Applicant: Pelican Pole LLC, Mableton, GA (US)

(72) Inventors: Sean F. Carbonell, Mableton, GA (US); Nicholas Campion Godfrey, Charleston, SC (US); Aaron Hunter Pierce, Oviedo, FL (US); Benjamin John Thomas, Anderson, SC (US)

(21) Appl. No.: 18/940,365

(22) Filed: Nov. 7, 2024

Related U.S. Application Data
(63) Continuation-in-part of application No. 18/444,029, filed on Feb. 16, 2024.
Application No. 18/444,029 is a continuation of application No. PCT/US2022/040445, filed on Aug. 16, 2022.
Application No. PCT/US2022/040445 is a continuation of application No. 17/403,797, filed on Aug. 16, 2021, now Pat. No. 11,679,935.

(51) Int. Cl. B65G 7/12; A45F 3/10

(52) U.S. Cl. CPC B65G 7/12; A45F 3/10

(57) ABSTRACT

A portable carrying apparatus configured to selectively attach a cargo load to one or more attachment points and enable a user to balance and carry the attached cargo load on one or both of the user's shoulders. A portable carrying apparatus of the present disclosure may include an elongated body comprising a first plurality of receiving portions disposed on a first arm portion and a second plurality of receiving portions disposed on a second arm portion. One or more attachment connectors may be selective interfaced with the first plurality of receiving portions. A user may selectively attach one or more cargo loads to the one or more attachment connectors in order to carry the cargo loads on the shoulder(s) of the user via the portable carrying apparatus.

### CROSS-REFERENCE TO RELATED APPLICATIONS

The present application is a continuation-in-part of U.S. application Ser. No. 18/444,029, entitled “PORTABLE LOAD DISTRIBUTING CARRYING APPARATUS” and filed on Feb. 16, 2024, which is a continuation of PCT Application Number PCT/US2022/040445, filed on Aug. 16, 2022, which is a continuation of U.S. application Ser. No. 17/403,797, filed on Aug. 16, 2021, now U.S. Pat. No. 11,679,935; the contents of which are hereby incorporated in their entireties herein at least by virtue of this reference.

### FIELD

The present disclosure relates to the field of outdoor tools and accessories; in particular, a portable load distributing carrying apparatus that may be balanced on the shoulder(s) of a user.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

An object of the present disclosure is a portable carrying apparatus, comprising an elongated body comprising a first load bearing portion disposed on a proximal area of the elongated body, a second load bearing portion disposed on a distal area of the elongated body opposite the first load bearing portion, and a balancing portion comprising a central area of the elongated body, wherein the first load bearing portion and the second load bearing portion each comprises a plurality of concavities disposed on an upper surface of the elongated body, wherein the first load bearing portion comprises a first elongated aperture extending through the first load bearing portion, and the second load bearing portion comprises a second elongated aperture extending through the second load bearing portion.

In accordance with certain embodiments, the portable carrying apparatus may further comprise at least one attachment connector selectively interfaced with one or more concavity in the plurality of concavities. In certain embodiments, the at least one attachment connector may comprise a cylindrical body configured to selectively interface with the one or more concavity. In certain embodiments, the portable carrying apparatus may further comprise a strap portion extending laterally from the cylindrical body. The strap portion may be configured to extend through the first elongated aperture or the second elongated aperture when the at least one attachment connector is selectively interfaced with the one or more concavity. In certain embodiments, the balancing portion of the elongated body may comprise a concave lower surface.

Another object of the present disclosure is a portable carrying apparatus, comprising a first arm comprising a first frame, the first frame comprising a first connector portion and a first plurality of attachment protrusions; a second arm comprising a second frame, the second frame comprising a second connector portion and a second plurality of attachment protrusions; and a body portion comprising a first attachment interface and a second attachment interface, wherein the first connector portion of the first arm is mateably coupled with the first attachment interface of the body portion and the second connector portion of the second arm is mateably coupled with the second attachment interface of the body portion.

In accordance with certain embodiments, the first plurality of attachment protrusions are disposed on a lateral portion of the first frame and the second plurality of attachment protrusions are disposed on a lateral portion of the first frame. In certain embodiments, the first frame comprises a handle portion at a distal end of the first frame and the second frame comprises a handle portion at a distal end of the second frame. In certain embodiments, an upper portion of the body portion may comprise a handle.

Yet another object of the present disclosure is a portable carrying apparatus, comprising a first arm comprising a first load bearing portion; a second arm comprising a second load bearing portion; and an elongated body portion, wherein the first arm is rotatably coupled to the elongated body portion at a first end of the elongated body portion and the second arm is rotatably coupled to the elongated body portion at a second end of the elongated body portion, wherein the first arm and the second arm are selectively configured to rotate from a first position comprising a collapsed configuration to a second position comprising an extended configuration.

In accordance with certain embodiments, the elongated body portion may comprise an elongated aperture disposed on a central area of the elongated body portion. The first arm and the second arm may be positioned within the elongated aperture when selectively configured in the collapsed configuration. In certain embodiments, the first load bearing portion comprises a plurality of concavities disposed on an upper surface of the first arm and the second load bearing portion comprises a plurality of concavities disposed on an upper surface of the second arm. In certain embodiments, the first load bearing portion comprises an elongated aperture extending through the first load bearing portion adjacent to the plurality of concavities and the second load bearing portion comprises an elongated aperture extending through the second load bearing portion adjacent to the plurality of concavities.

Still further aspects of the present disclosure provide for a portable carrying apparatus comprising an elongated body portion comprising a first end and a second end and a hollow interior portion; a first arm portion coupled to the first end of the elongated body portion, wherein the first arm portion is slidably interfaced with the hollow interior portion of the elongated body portion; a second arm portion coupled to the second end of the elongated body portion, wherein the second arm portion is slidably interfaced with the hollow interior portion of the elongated body portion; a first attachment means coupled to a distal end of the first arm portion, wherein the first attachment means is configured to receive a first cargo load; and a second attachment means coupled to a distal end of the second arm portion, wherein the second attachment means is configured to receive a second cargo load. In accordance with certain embodiments, the first arm portion and the second arm portion are configured to be selectively extended or retracted from the hollow interior portion.

In accordance with certain embodiments, the portable carrying apparatus may further comprise a first reducer housing coupled to the first end of the elongated body portion, wherein the first reducer housing is slidably interfaced with the first arm portion. In accordance with said embodiments, the portable carrying apparatus may further comprise a second reducer housing coupled to the second end of the elongated body portion, wherein the second reducer housing is slidably interfaced with the second arm portion. In certain embodiments, the portable carrying apparatus may further comprise a first locking means configured to be interfaced with the first arm portion to selectively secure the first arm portion at a fixed position. In accordance with said embodiments, the portable carrying apparatus may further comprise a second locking means configured to be interfaced with the second arm portion to selectively secure the second arm portion at a fixed position. In certain embodiments, the first attachment means or the second attachment means comprises a loop portion. The first arm portion may comprise one or more apertures disposed on a surface of the first arm portion, wherein the first locking means is configured to be interfaced with the one or more apertures to selectively secure the first arm portion at the fixed position. The second arm portion may comprise one or more apertures disposed on a surface of the second arm portion, wherein the second locking means is configured to be interfaced with the one or more apertures to selectively secure the second arm portion at the fixed position. In certain embodiments, the first arm portion and the second arm portion are configured to be independently positioned to adjust a center of gravity of the elongated body portion.

Still further aspects of the present disclosure provide for a portable carrying apparatus comprising a body portion comprising a curved central portion and a first connector portion extending from a first side of the curved central portion and a second connector portion extending from a second side of the curved central portion; a first arm portion comprising a proximal end and a distal end, wherein the proximal end of the first arm portion is configured to be selectively interfaced with the first connector portion to securely couple the first arm portion to the body portion; a second arm portion comprising a proximal end and a distal end, wherein the proximal end of the second arm portion is configured to be selectively interfaced with the second connector portion to securely couple the second arm portion to the body portion; a first attachment means coupled to the distal end of the first arm portion, wherein the first attachment means is configured to receive a first cargo load; and a second attachment means coupled to the distal end of the second arm portion, wherein the second attachment means is configured to receive a second cargo load. In certain embodiments, the first arm portion and the second arm portion are configured to be selectively disconnected from the body portion.

In accordance with certain embodiments of the portable carrying apparatus, the first attachment means or the second attachment means may comprise a loop portion and/or a grommet portion. In certain embodiments, the first arm portion and the second arm portion each comprise an elongated tube. The first connector portion and the second connector portion may each comprise a threaded interface. In certain embodiments, the curved central portion of the body portion is configured to be interfaced with a user's shoulder. In certain embodiments, the first arm portion comprises at least one aperture configured to receive a cord or rope therethrough. In certain embodiments, the second arm portion comprises at least one aperture configured to receive a cord or rope therethrough. In certain embodiments, the body portion comprises a first load reinforcing portion disposed on the first side of the curved central portion. In accordance with said embodiments, the body portion may comprise a second load reinforcing portion disposed on the second side of the curved central portion.

Still further aspects of the present disclosure provide for a portable carrying apparatus comprising a body portion comprising a first end and a second end and a hollow interior portion; a first reducer housing coupled to the first end of the body portion; a second reducer housing coupled to the second end of the body portion; a first carrying arm slidably interfaced with the first reducer housing, wherein the first carrying arm is configured to be selectively extended or retracted from the hollow interior portion of the body portion; and a second carrying arm slidably interfaced with the second reducer housing, wherein the second carrying arm is configured to be selectively extended or retracted from the hollow interior portion of the body portion, wherein the first carrying arm is configured to carry a first cargo load and the second carrying arm is configured to carry a second cargo load.

The foregoing has outlined rather broadly the more pertinent and important features of the present invention so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present invention. It should be realized by those skilled in the art that such equivalent structures do not depart from the spirit and scope of the invention as set forth in the appended claims.

### BRIEF DESCRIPTION OF DRAWINGS

The skilled artisan will understand that the figures, described herein, are for illustration purposes only. It is to be understood that in some instances various aspects of the described implementations may be shown exaggerated or enlarged to facilitate an understanding of the described implementations. In the drawings, like reference characters generally refer to like features, functionally similar and/or structurally similar elements throughout the various drawings. The drawings are not necessarily to scale, emphasis instead being placed upon illustrating the principles of the teachings. The drawings are not intended to limit the scope of the present teachings in any way. The system and method may be better understood from the following illustrative description with reference to the following drawings in which:

FIG. 1 is a perspective view of a portable carrying apparatus, in accordance with certain aspects of the present disclosure;

FIG. 2 is an enlarged view of a load bearing portion of the portable carrying apparatus, in accordance with certain aspects of the present disclosure;

FIG. 3 is an enlarged view of an attachment connector of the portable carrying apparatus, in accordance with certain aspects of the present disclosure;

FIG. 4 is a perspective view of a portable carrying apparatus, in accordance with certain aspects of the present disclosure;

FIG. 5 is an enlarged view of a body portion of the portable carrying apparatus, in accordance with certain aspects of the present disclosure;

FIG. 6 is a component view of the portable carrying apparatus, in accordance with certain aspects of the present disclosure;

FIG. 7 is a functional perspective view of a portable carrying apparatus, in accordance with certain aspects of the present disclosure;

FIG. 8 is a functional perspective view of a portable carrying apparatus, in accordance with certain aspects of the present disclosure;

FIG. 9 is a front elevation of a portable carrying apparatus in a collapsed configuration, in accordance with certain aspects of the present disclosure;

FIG. 10 is a front elevation of a portable carrying apparatus in an extended configuration, in accordance with certain aspects of the present disclosure;

FIG. 11 is a perspective view of a portable carrying apparatus in a collapsed configuration, in accordance with certain aspects of the present disclosure;

FIG. 12 is a perspective view of a portable carrying apparatus in an extended configuration, in accordance with certain aspects of the present disclosure;

FIG. 13 is a front elevation of a portable carrying apparatus in an assembled configuration, in accordance with certain aspects of the present disclosure;

FIG. 14 is a front elevation of a portable carrying apparatus in a disassembled configuration, in accordance with certain aspects of the present disclosure;

FIG. 15 is a perspective view of a portable carrying apparatus in an assembled configuration, in accordance with certain aspects of the present disclosure;

FIG. 16 is a perspective view of a portable carrying apparatus in a disassembled configuration, in accordance with certain aspects of the present disclosure.

FIG. 17 is a perspective view of a portable carrying apparatus in an assembled configuration, in accordance with certain aspects of the present disclosure;

FIG. 18 is a front elevation of a portable carrying apparatus in an assembled configuration, in accordance with certain aspects of the present disclosure;

FIG. 19 is a plan view of a portable carrying apparatus in a disassembled configuration, in accordance with certain aspects of the present disclosure;

FIG. 20 is a perspective view of a portable carrying apparatus in a disassembled configuration, in accordance with certain aspects of the present disclosure;

FIG. 21 is a cutaway view a portable carrying apparatus, in accordance with certain aspects of the present disclosure; and

FIG. 22 is a cross-sectional view a portable carrying apparatus, in accordance with certain aspects of the present disclosure.

### DETAILED DESCRIPTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout. All definitions, as defined and used herein, should be understood to control over dictionary definitions, definitions in documents incorporated by reference, and/or ordinary meanings of the defined terms.

Following below are more detailed descriptions of various concepts related to, and embodiments of, inventive methods, devices and systems configured to provide for a portable carrying apparatus configured to selectively attach a cargo load to one or more attachment points and enable a user to balance and carry the attached cargo load on one or both of the user's shoulders.

It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes. The present disclosure should in no way be limited to the exemplary implementation and techniques illustrated in the drawings and described below.

Where a range of values is provided, it is understood that each intervening value, to the tenth of the unit of the lower limit unless the context clearly dictates otherwise, between the upper and lower limit of that range and any other stated or intervening value in that stated range is encompassed by the invention. The upper and lower limits of these smaller ranges may independently be included in the smaller ranges, and are also encompassed by the invention, subject to any specifically excluded limit in a stated range. Where a stated range includes one or both of the endpoint limits, ranges excluding either or both of those included endpoints are also included in the scope of the invention.

As used herein, “exemplary” means serving as an example or illustration and does not necessarily denote ideal or best.

As used herein, the term “includes” means includes but is not limited to, the term “including” means including but not limited to. The term “based on” means based at least in part on.

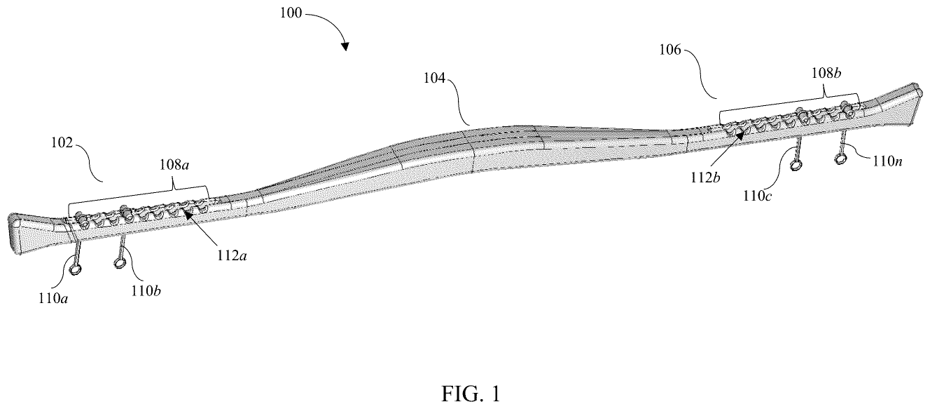

Turning now descriptively to the drawings, in which similar reference characters denote similar elements throughout the several views, FIG. 1 depicts a portable carrying apparatus 100. In accordance with certain aspects of the present disclosure, portable carrying apparatus 100 may be configured as an elongated, unitary body comprising a first load bearing portion 102, a body portion 104 and a second load bearing portion 106. First load bearing portion 102 may extend laterally from a first side of body portion 104 and second load bearing portion 106 may extend laterally from a second side of body portion 104, such that first load bearing portion 102 extends in an opposite direction from second load bearing portion 106. Body portion 104 may be thicker in width than first load bearing portion 102 and second load bearing portion 106 in order to increase the tensile strength of portable carrying apparatus 100 and help distribute the weight of a cargo load attached to portable carrying apparatus 100 when carried by a user. Body portion 104 may be curved at a lower surface to improve comfort to a user when portable carrying apparatus 100 is balanced on one or both shoulders of a user when in use. In accordance with certain embodiments, portable carrying apparatus 100 may further comprise a first plurality of concavities 108a disposed on an upper surface of first load bearing portion 102 and a second plurality of concavities 108b disposed on an upper surface of second load bearing portion 106. In accordance with certain embodiments, the plurality of concavities 108a,b is configured as semi-circular or notched portions disposed on the upper surface of portable carrying apparatus 100. In accordance with certain embodiments, plurality of concavities 108a,b may comprise receiving portions configured to receive a peg, connector or other attachment mechanism. The plurality of concavities 108a,b may be configured to mateably interface with an upper portion of an attachment connector 110a,b,c . . . n. In accordance with certain embodiments, portable carrying apparatus 100 may further comprise a first channel 112a extending through portable carrying apparatus 100 at first load bearing portion 102 and a second channel 112b extending through portable carrying apparatus 100 at second load bearing portion 106.

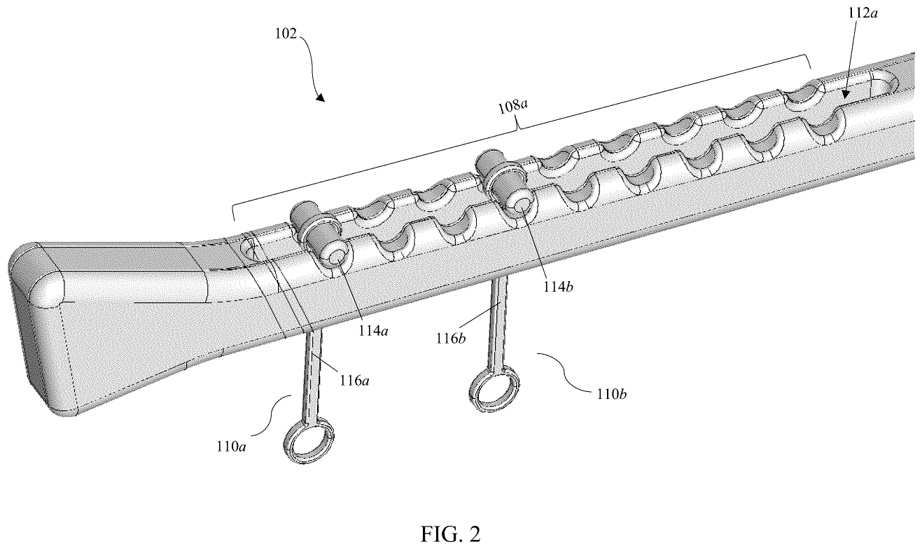

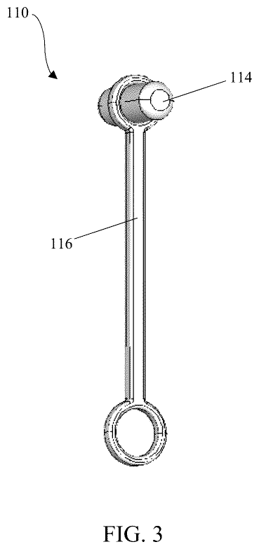

Referring now to FIGS. 2 and 3, an enlarged view of first load bearing portion 102 and an attachment connector 110 of portable carrying apparatus 100 is shown. As shown in FIG. 3, an attachment connector of portable carrying apparatus 100 may comprise a strap portion 116 and a peg portion 114. Strap portion 116 may comprise an elongated strap with an upper aperture and a lower aperture. The upper aperture of strap portion 116 may be configured to be securely coupled to a circumference of peg portion 114. The lower aperture of strap portion 116 may be configured to receive a hook, carabiner, rope, and/or other attachment means configured to selectively couple a cargo load to portable carrying apparatus 100. In certain embodiments, peg portion 114 may be configured as a three-dimensional shape (such as a cylinder, triangular prism, etc.) configured to mateably interfaced with the receiving portion of the plurality of concavities 108a,b. In accordance with certain embodiments, attachment connectors 110a,b may be selectively interfaced with first load bearing portion 102 as shown in FIG. 2. Strap portion 116a,b may extend through first channel 112a until peg portion 114a,b interfaces with the desired concavity in the plurality of concavities 110a,b.

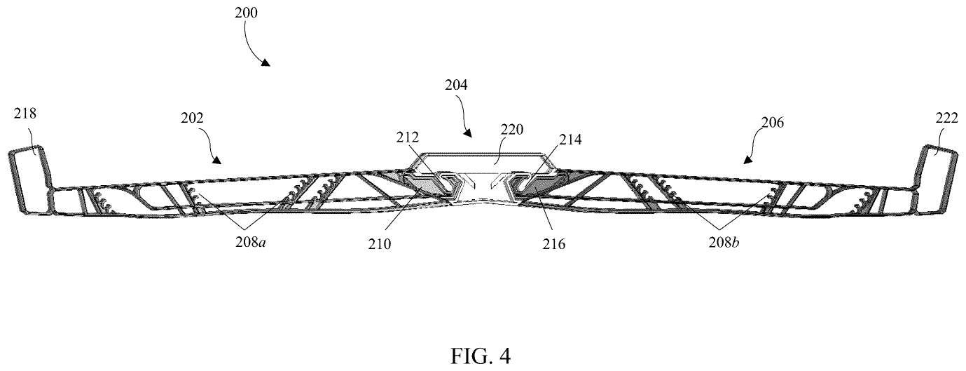

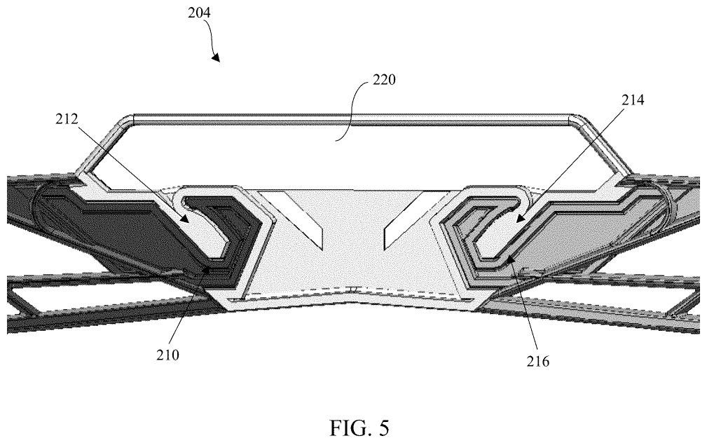

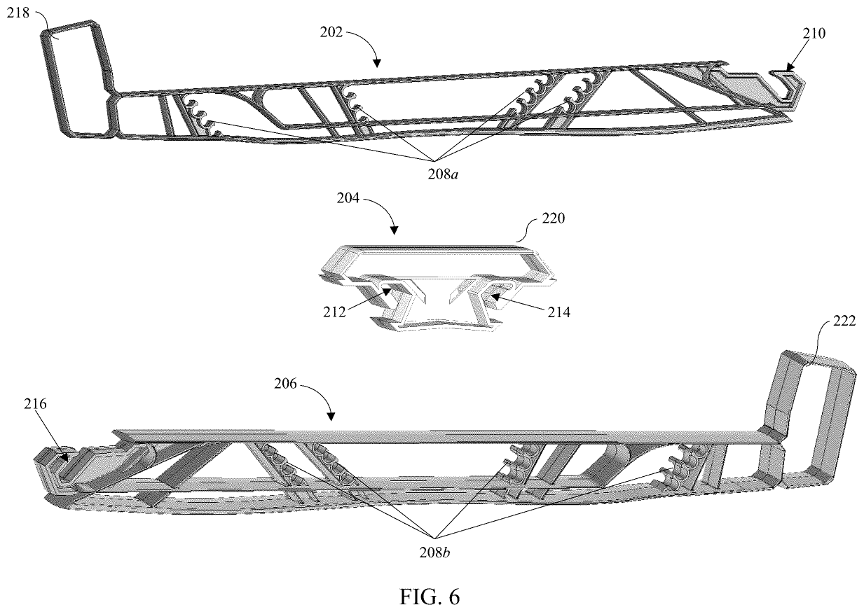

Referring now to FIG. 4, a perspective view of a portable carrying apparatus 200 is shown. In accordance with certain aspects of the present disclosure, portable carrying apparatus 200 comprises an alternative embodiment of the present invention to portable carrying apparatus 100 as shown in FIG. 1. In accordance with an embodiment, portable carrying apparatus 200 comprises a first arm portion 202, a body portion 204, and a second arm portion 206. First arm portion 202, a central body portion 204, and a second arm portion 206 may be configured as a frame structure and may be constructed from plastic, metal and the like. First arm portion 202 may comprise a first plurality of attachment protrusions 208a disposed on one or more lateral support members of the frame structure of first arm portion 202. First arm portion 202 may further comprise a handle portion 218 at one end of first arm portion 202 and a connector portion 210 at a second end of first arm portion 202. Second arm portion 206 may comprise a second plurality of attachment protrusions 208b disposed on one or more lateral support members of the frame structure of second arm portion 206. In accordance with certain embodiments, a user of portable carrying apparatus 200 may selectively attach a hook, carabiner, rope, or other attachment means to the first and second plurality of attachment protrusions 208a,b in order to selectively attach a cargo load to portable carrying apparatus 200. In accordance with various embodiments, a user may selectively attach a first cargo load to one or more attachment protrusions in the first plurality of attachment protrusions 208a and a second cargo load to one or more attachment protrusions in the second plurality of attachment protrusions 208b such that the first cargo load and the second cargo load are balanced along a center of gravity extending through a longitudinal axis of body portion 204. In accordance with certain aspects of the present disclosure, a user may position the cargo load(s) upwards, downwards, laterally or medially at one or more of attachment protrusions 208a,b in order to ensure a balanced center of gravity for the cargo loads when selectively attached to portable carrying apparatus 200. Second arm portion 206 may further comprise a second handle portion 222 at one end of second arm portion 206 and a connector portion 216 at a second end of second arm portion 206. In accordance with certain embodiments, body portion 204 may comprise a first arm attachment portion 212 and a second arm attachment portion 214. Body portion 204 may optionally comprise a handle portion 220. In accordance with certain embodiments, first arm attachment portion 212 of body portion 204 may be mateably coupled to connector portion 210 of first arm portion 202; and second arm attachment portion 214 of body portion 204 may be mateably coupled to connector portion 216 of second arm portion 206 (as shown in FIG. 5). As shown in FIG. 6, portable carrying apparatus 200 may be selectively deconstructed/disassembled by detaching first arm portion 202 and second arm portion 206 from body portion 204.

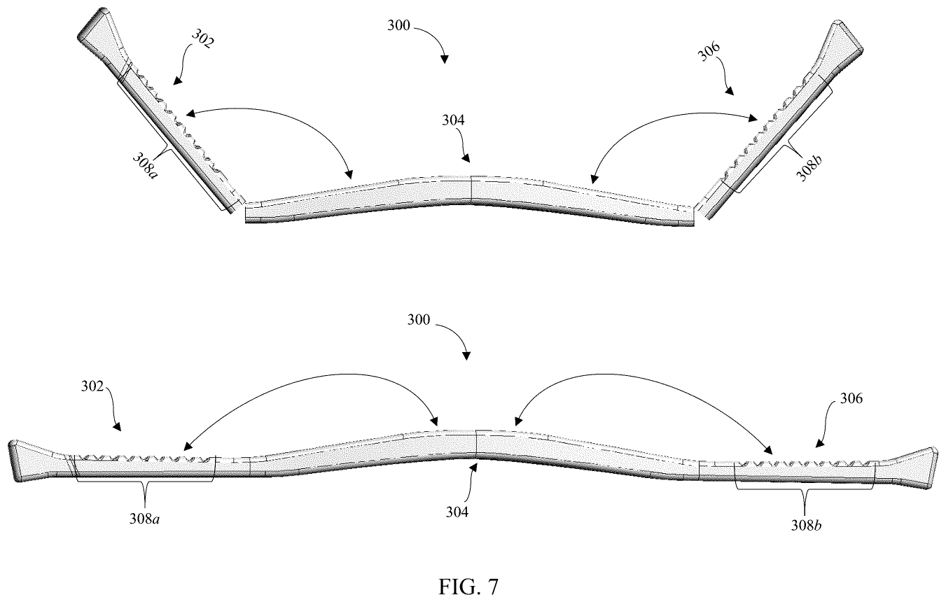

Referring now to FIG. 7, a functional perspective view of a portable carrying apparatus 300 is shown. In accordance with certain aspects of the present disclosure, portable carrying apparatus 300 may comprise an alternative embodiment of the present invention to those shown in FIGS. 1 and 2. In accordance with certain aspects of the present disclosure, portable carrying apparatus 300 may be comprised of a first arm portion 302, a body portion 304 and a second arm portion 306. In accordance with certain embodiments, first arm portion 302 may comprise a first plurality of concavities 308a disposed on an upper surface of first arm portion 302; and second arm portion 306 may comprise a second plurality of concavities 308b disposed on an upper surface of second arm portion 306. In accordance with certain aspects of the present disclosure, the plurality of concavities 308a,b may be configured as concavities 108a,b, as shown in FIG. 1. In accordance with certain embodiments, first arm portion 302 may be rotatably coupled to a first end of body portion 304 and second arm portion 306 may be rotatably coupled to a second end of body portion 304 such that first arm portion 302 and second arm portion 306 may be selectively rotated from a folded configuration (when not in use) to an extended configuration (when in use). In accordance with certain embodiments, first arm portion 302 and second arm portion 306 may rotate approximately 180 degrees such that first arm portion 302 and second arm portion 306 are selectively housed within a channel or aperture of body portion 304 when configured in the folded configuration.

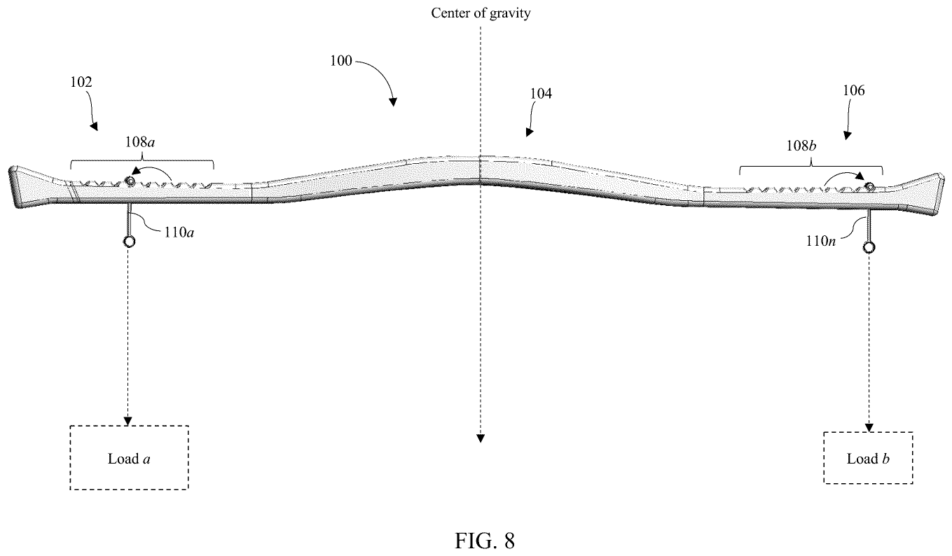

Referring now to FIG. 8, a functional perspective view of portable carrying apparatus 100 is shown. In accordance with certain aspects of the present disclosure, a user of portable carrying apparatus 100 may attach a first cargo Load a to a first attachment connector 110a and a second cargo Load b to a second attachment connector 110n. A user may selectively position first attachment connector 110a at a concavity along the first plurality of concavities 108a and may selectively position second attachment connector 110n at a concavity along the second plurality of concavities 108b such that a center of gravity for portable carrying apparatus 100 is substantially in the center of body portion 104 when portable carrying apparatus 100 is under load. A user may selectively move first attachment connector 110a and/or second attachment connector 110n to the left or right (i.e., laterally or medially) as necessary to better balance Load a and Load b when portable carrying apparatus 100 is worn by the user. In accordance with various aspects of the present disclosure, body portion 104 may be balanced on one or both shoulders of a user when portable carrying apparatus 100 is worn by the user.

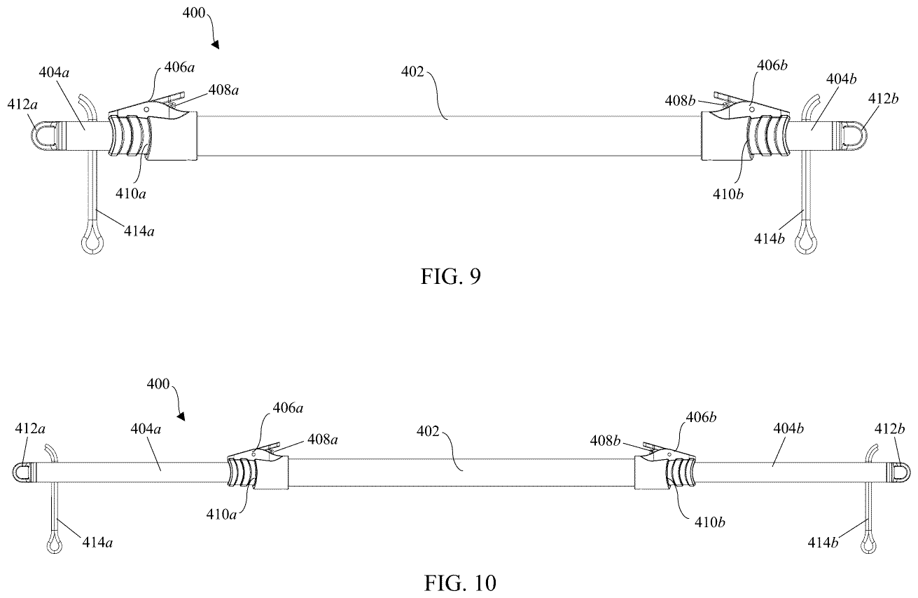

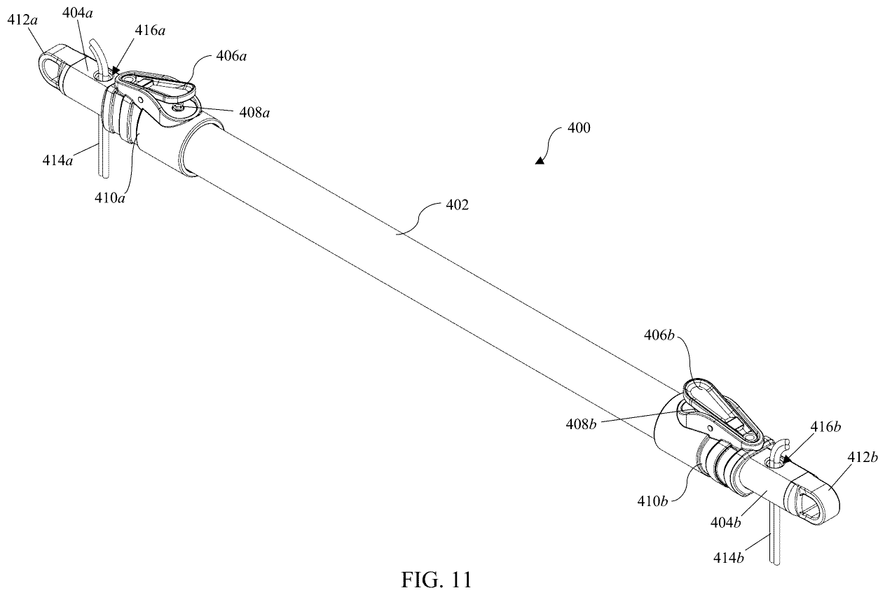

Referring now to FIGS. 9-12, various views of a portable carrying apparatus 400 are shown. In accordance with certain aspects of the present disclosure, portable carrying apparatus 400 comprises an alternative embodiment of apparatus 100 (as shown in FIG. 1) and/or an alternative embodiment of apparatus 200 (as shown in FIG. 4) and/or an alternative embodiment of apparatus 300 (as shown in FIG. 7). In accordance with certain embodiments, apparatus 400 comprises a body portion 402, a first carrying arm 404a and a second carrying arm 404b. In accordance with certain aspects of the present disclosure, apparatus 400 may be selectively configurable by a user between an extended configuration (as shown in FIG. 10) and a collapsed configuration (as shown in FIG. 9) (as well as any position therebetween). In certain embodiments, body portion 402 may comprise an elongated, tubular structure comprising a hollow interior portion. In accordance with certain embodiments, a length of first carrying arm 404a and second carrying arm 404b may each be housed in the hollow interior portion of body portion 402 when apparatus 400 is configured in the collapsed configuration (e.g., as shown in FIG. 9). Body portion 402 may comprise a first diameter and each of first carrying arm 404a and second carrying arm 404b may comprise a second diameter. The second diameter may be smaller than the first diameter such that first carrying arm 404a and second carrying arm 404b fit inside the hollow interior portion of body portion 402.

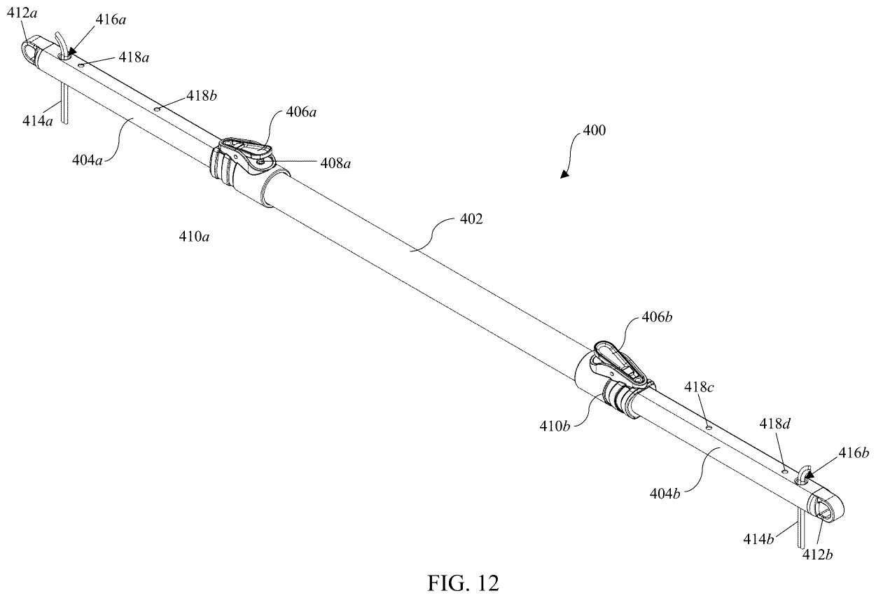

In accordance with certain aspects of the present disclosure, apparatus 400 may further comprise a first reducer housing 410a and a second reducer housing 410b. First reducer housing 410a and second reducer housing 410b may each comprise a first end comprising a first aperture having a first diameter configured to (respectively) receive first carrying arm 404a and second carrying arm 404b therethrough. First reducer housing 410a and second reducer housing 410b may each comprise a second end comprising a second aperture having a second diameter configured to (respectively) receive an end of body portion 402. In accordance with certain aspects of the present disclosure, first reducer housing 410a and second reducer housing 410b are configured to reduce the diameter of body portion 402 such that first carrying arm 404a and second carrying arm 404b may respectively establish a friction-fit, slidable interface with first reducer housing 410a and second reducer housing 410b (e.g., to slide between the extended position and the collapsed position). In accordance with certain aspects of the present disclosure, apparatus 400 may further comprise a first actuator 406a and a second actuator 406b. First actuator 406a and second actuator 406b may (respectively) be operably engaged with a first spring 408a and a second spring 408b. First spring 408a and second spring 408b may (respectively) be configured to exert force against a first surface of first actuator 406a and a first surface of second actuator 406b such that a second surface of first actuator 406a and a second surface of second actuator 406b are (respectively) forced in contact with a surface of first reducer housing 410a and second reducer housing 410b. In accordance with certain aspects of the present disclosure, first actuator 406a and second actuator 406b each comprise a protrusion extending from the second surface of first actuator 406a and second actuator 406b. In accordance with certain embodiments, each protrusion is configured to interface with a surface of first carrying arm 404a and second carrying arm 404b. In certain embodiments (e.g., as shown in FIG. 12), first carrying arm 404a and second carrying arm 404b may comprise one or more apertures 418a-d. In accordance with said embodiments, first actuator 406a is configured to selectively interface with aperture 418a or 418b to selectively retain first carrying arm 404a at a desired position (e.g., corresponding with aperture 418a or 418b). In accordance with said embodiments, second actuator 406b is also configured to selectively interface with aperture 418c or 418d to selectively retain second carrying arm 404b at a desired position (e.g., corresponding with aperture 418c or 418d). In accordance with certain embodiments, first actuator 406a and second actuator 406b are pivotably engaged with first reducer housing 410a and second reducer housing 410b such that a user may press on a surface of first actuator 406a and second actuator 406b (e.g., adjacent to first spring 408a and second spring 408b) to disengage first actuator 406a and second actuator 406b from first carrying arm 404a and second carrying arm 404b. In accordance with certain aspects of the present disclosure, the user may slide first carrying arm 404a and/or second carrying arm 404b into a desired position while first actuator 406a and/or second actuator 406b are disengaged from first carrying arm 404a and second carrying arm 404b. The user may release first actuator 406a and/or second actuator 406b to selectively lock first carrying arm 404a and/or second carrying arm 404b in the desired position.

In accordance with certain embodiments, apparatus 400 may further comprise a first connector portion 412a disposed on a distal end of first carrying arm 404a and a second connector portion 412b disposed on a distal end of second carrying arm 404b. First connector portion 412a and second connector portion 412b may comprise an aperture or grommet configured to receive a clip, cord, carabiner, and/or other attachment means. In accordance with certain aspects of the present disclosure, a user may connect a first cargo load to first connector portion 412a and/or a second cargo load to second connector portion 412b such that the user may carry the first cargo load and/or the second cargo load via apparatus 400 by balancing body portion 402 on the user's shoulder. In certain embodiments, apparatus 400 may further comprise a first attachment means 414a coupled to first carrying arm 404a and/or a second attachment means 414b coupled to second carrying arm 404b. In certain embodiments, first attachment means 414a and second attachment means 414b may comprise a rope, cord, wire, molded plastic component, and the like. In certain embodiments, first attachment means 414a and second attachment means 414b may (respectively) extend through a first attachment aperture 416a and a second attachment aperture 416b (as shown in FIG. 12) of first carrying arm 404a and second carrying arm 404b. In certain embodiments, first attachment aperture 416a and second attachment aperture 416b are (respectively) configured to retain a portion of first attachment means 414a and second attachment means 414b such that first attachment means 414a and second attachment means 414b may hang or extend vertically from first carrying arm 404a and second carrying arm 404b. In certain embodiments, first attachment means 414a and second attachment means 414b may comprise a loop portion configured to receive a clip, cord, rope, carabiner, and/or other attachment means. In accordance with certain aspects of the present disclosure, a user may connect a first cargo load to first attachment means 414a and/or a second cargo load to second attachment means 414b such that the user may carry the first cargo load and/or the second cargo load via apparatus 400 by balancing body portion 402 on the user's shoulder. In accordance with certain aspects of the present disclosure, the user may adjust the center of gravity of apparatus 400 (e.g., when carrying a cargo load) by sliding first carrying arm 404 and/or second carrying arm 404b to a desired position (e.g., by extending or contracting first carrying arm 404a and/or second carrying arm 404b from body portion 402).

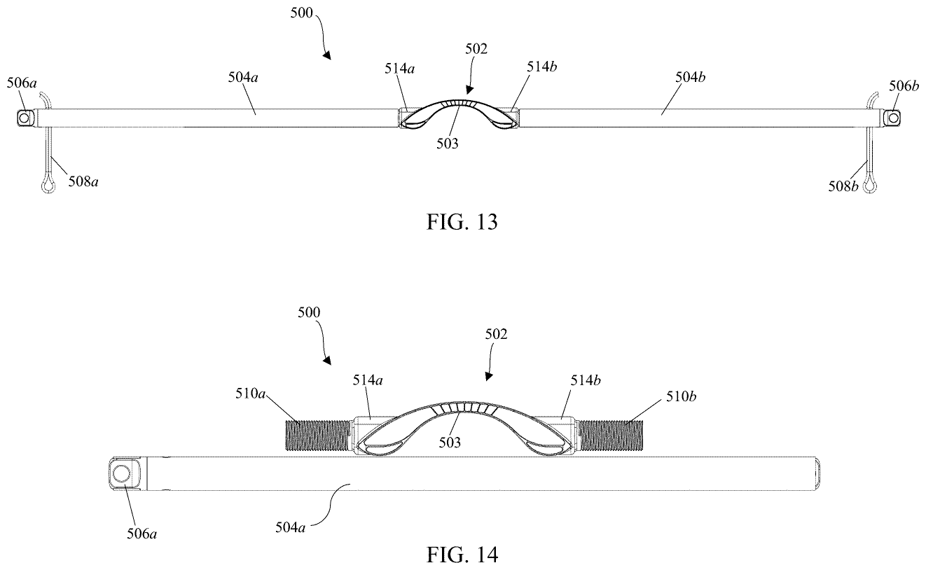

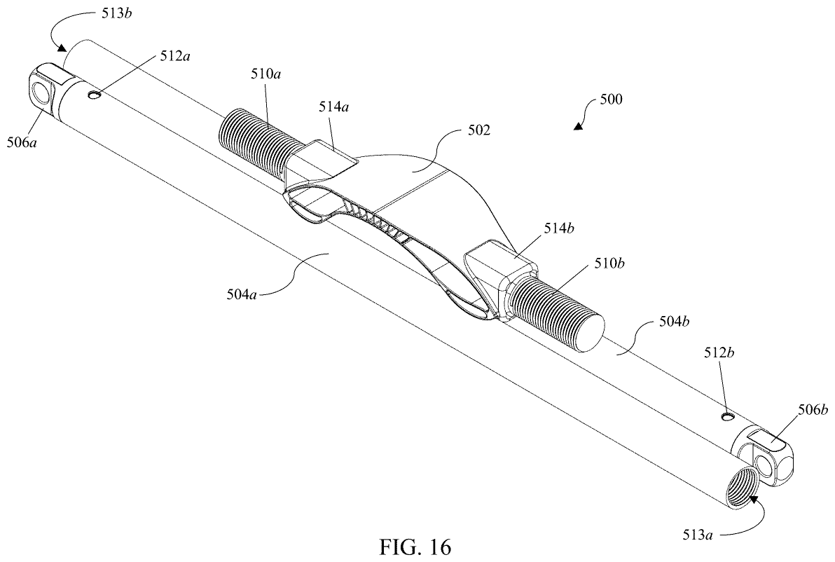

Referring now to FIGS. 13-16, various views of a portable carrying apparatus 500 are shown. In accordance with certain aspects of the present disclosure, portable carrying apparatus 500 comprises an alternative embodiment of apparatus 100 (as shown in FIG. 1) and/or an alternative embodiment of apparatus 200 (as shown in FIG. 4) and/or an alternative embodiment of apparatus 300 (as shown in FIG. 7) and/or an alternative embodiment of apparatus 400 (as shown in FIG. 9). In accordance with certain aspects of the present disclosure, apparatus 500 comprises body portion 502, a first carrying arm 504a and a second carrying arm 504b. In accordance with certain embodiments, first carrying arm 504a and second carrying arm 504b may be selectively coupled to body portion 502 in a first configuration (as shown in FIG. 13) or selectively disengaged from body portion 502 in a second configuration (as shown in FIG. 14). In accordance with certain embodiments, body portion 502 may comprise a unitary structure comprising a single molded plastic piece. In other embodiments, body portion 502 may comprise a multi-piece construction. Body portion 502 may comprise a curved portion 503 configured to interface with a shoulder area of a user (i.e., between the user's shoulder and neck). Body portion 502 may further comprise a first load reinforcing portion 514a and a second load reinforcing portion 514b disposed on opposite sides of curved portion 503. Body portion 502 may further comprise a first connector portion 510a coupled to first load reinforcing portion 514a and a second connector portion 510b coupled to second load reinforcing portion 514b. In accordance with certain aspects of the present disclosure, first load reinforcing portion 514a and second load reinforcing portion 514b are configured to increase the tensile strength of body portion 502 and provide spring dampening when apparatus 500 is carrying a cargo load. In accordance with certain aspects of the present disclosure, first connector portion 510a is configured to interface with an open end 513a (as shown in FIG. 16) of first carrying arm 504a and second connector portion 510b is configured to interface with an open end 513b (as shown in FIG. 16) of second carrying arm 504b. In certain embodiments, first connector portion 510a and second connector portion 510b may comprise a male threaded portion and the open ends 513a-b of first connector portion 510a and second connector portion 510b may comprise a complementary female threaded portion. In accordance with certain embodiments, first carrying arm 504a may be securely coupled to first connector portion 510a via the threaded interface between open end 513a and first connector portion 510a and second carrying arm 504b may be securely coupled to second connector portion 510b via the threaded interface between open end 513b and second connector portion 510b. Various other types of mechanical interfaces other than threads are readily anticipated.

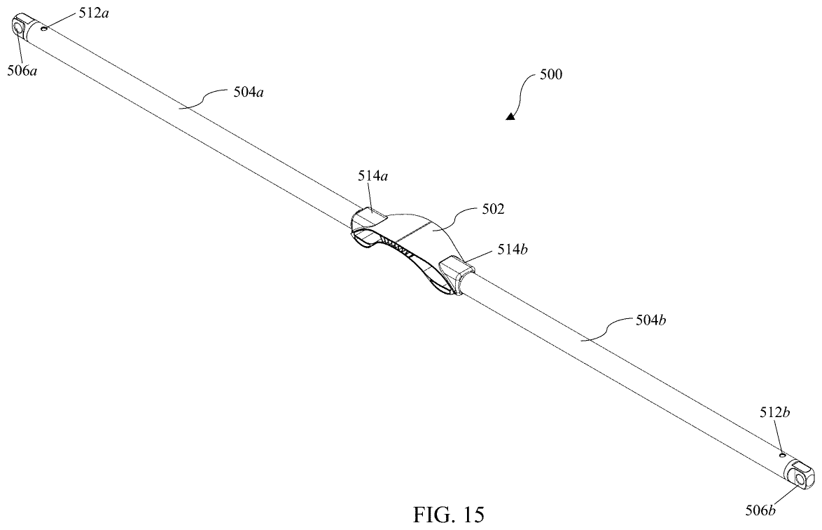

In accordance with certain embodiments, apparatus 500 may further comprise a first connector portion 506a disposed on a distal end of first carrying arm 504a and a second connector portion 506b disposed on a distal end of second carrying arm 504b. First connector portion 506a and second connector portion 506b may comprise an aperture or grommet configured to receive a clip, cord, carabiner, rope and/or other attachment means. In accordance with certain aspects of the present disclosure, a user may connect a first cargo load to first connector portion 506a and/or a second cargo load to second connector portion 506b such that the user may carry the first cargo load and/or the second cargo load via apparatus 500 by balancing body portion 502 on the user's shoulder. In certain embodiments, apparatus 500 may further comprise a first attachment means 508a coupled to first carrying arm 504a and/or a second attachment means 508b coupled to second carrying arm 504b. In certain embodiments, first attachment means 508a and second attachment means 508b may comprise a rope, cord, wire, molded plastic component, and the like. In certain embodiments, first attachment means 508a and second attachment means 508b may (respectively) extend through a first attachment aperture 512a and a second attachment aperture 512b (as shown in FIG. 15) of first carrying arm 504a and second carrying arm 504b. In certain embodiments, first attachment aperture 512a and second attachment aperture 512b are (respectively) configured to secure a portion of first attachment means 508a and second attachment means 508b such that first attachment means 508a and second attachment means 508b may hang or extend vertically from first carrying arm 504a and second carrying arm 504b. In certain embodiments, first attachment means 508 and second attachment means 508b may comprise a loop portion configured to receive a clip, cord, rope, carabiner, and/or other attachment means. In accordance with certain aspects of the present disclosure, a user may connect a first cargo load to first attachment means 508a and/or a second cargo load to second attachment means 508b such that the user may carry the first cargo load and/or the second cargo load via apparatus 500 by balancing body portion 502 on the user's shoulder.

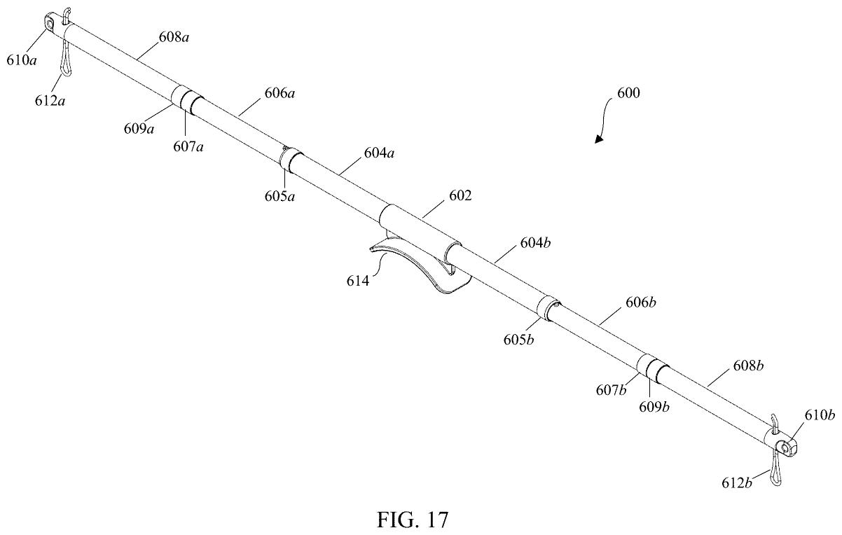

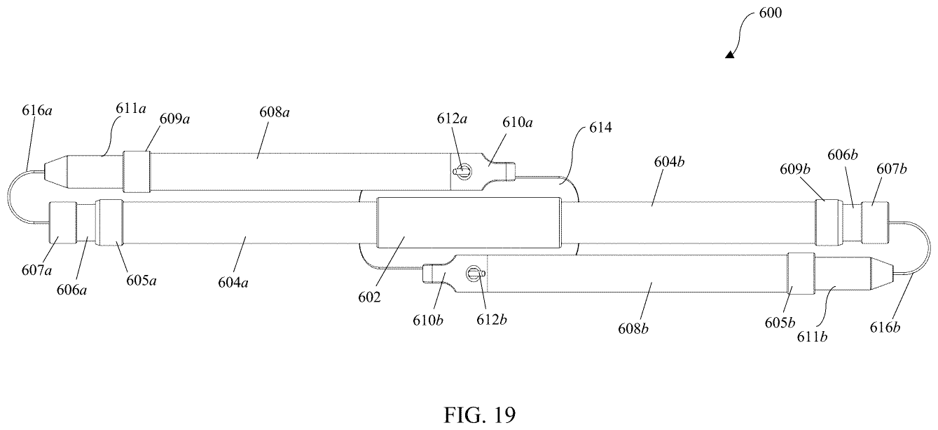

Referring now to FIGS. 17-22, various views of a portable carrying apparatus 600 are shown. In accordance with certain aspects of the present disclosure, portable carrying apparatus 600 comprises an alternative embodiment of apparatus 100 (as shown in FIG. 1) and/or an alternative embodiment of apparatus 200 (as shown in FIG. 4) and/or an alternative embodiment of apparatus 300 (as shown in FIG. 7) and/or an alternative embodiment of apparatus 400 (as shown in FIG. 9) and/or an alternative embodiment of apparatus 500 (as shown in FIG. 13). In accordance with certain aspects of the present disclosure, apparatus 600 comprises a central portion 602, a first carrying arm segment 604a, a second carrying arm segment 604b, a third carrying arm segment 606a, a fourth carrying arm segment 606b, a fifth carrying arm segment 608a and a sixth carrying arm segment 608b. In certain embodiments, central portion 602 comprises a shoulder rest portion 614 comprising a concave surface configured to interface with the shoulder of a user. In certain embodiments, first carrying arm segment 604a may comprise a first receiving portion 605a configured to receive a first end of third carrying arm segment 606a and second carrying arm segment 604b may comprise a second receiving portion 605b configured to receive a first end of fourth carrying arm segment 606b. In accordance with certain aspects of the present disclosure, third carrying arm segment 606a may be slidably engaged with first carrying arm segment 604a such that third carrying arm segment 606a may extend from and retract within an interior area of first carrying arm segment 604a; i.e., between an extended configuration (as shown in FIG. 17) and a retracted configuration (as shown in FIG. 19). Likewise, fourth carrying arm segment 606b may be slidably engaged with second carrying arm segment 604b such that fouth carrying arm segment 606b may extend from and retract within an interior area of second carrying arm segment 604b; i.e., between the extended configuration (as shown in FIG. 17) and the retracted configuration (as shown in FIG. 19).

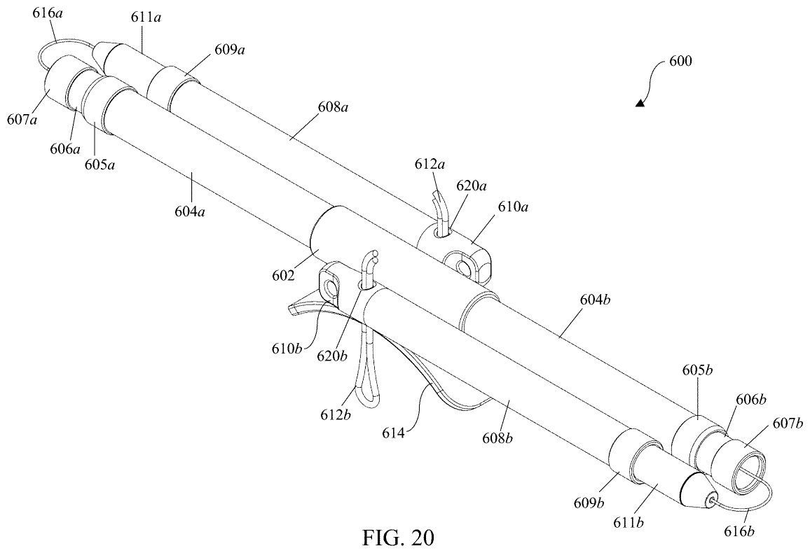

In accordance with certain aspects of the present disclosure, third carrying arm segment 606a may comprise a first collar portion 607a coupled to a distal end thereof, and fourth carrying arm segment 606b may comprise a second collar portion 607b coupled to a distal end thereof. In certain embodiments, fifth carrying arm segment 608a may comprise a third collar portion 609a coupled to a proximal end thereof, and sixth carrying arm segment 608b may comprise a fourth collar portion 609b coupled to a proximal end thereof. In certain embodiments, first collar portion 607a may be interfaced with fourth collar portion 609b when third carrying arm segment 606a is selectively coupled with fifth carrying arm segment 608a (e.g., as shown in FIG. 17). In said embodiments, second collar portion 607b may be interfaced with fourth collar portion 609b when fourth carrying arm segment 606b is selectively coupled with sixth carrying arm segment 608b (e.g., as shown in FIG. 17). In accordance with certain embodiments, apparatus 600 may further comprise a first connector portion 610a disposed on a distal end of fifth carrying arm segment 608a and a second connector portion 610b disposed on a distal end of sixth carrying arm segment 608b. First connector portion 610a and second connector portion 610b may comprise an aperture or grommet configured to receive a clip, cord, carabiner, rope and/or other attachment means. In accordance with certain aspects of the present disclosure, a user may connect a first cargo load to first connector portion 610a and/or a second cargo load to second connector portion 610b such that the user may carry the first cargo load and/or the second cargo load via apparatus 600 by balancing the shoulder rest portion 614 of central portion 602 on the user's shoulder. In certain embodiments, apparatus 600 may further comprise a first attachment means 612a coupled to fifth carrying arm segment 608a and/or a second attachment means 612b coupled to sixth carrying arm segment 608b. In certain embodiments, first attachment means 612a and second attachment means 612b may comprise a rope, cord, wire, molded plastic component, and the like. In certain embodiments, first attachment means 612a and second attachment means 612b may (respectively) extend through a first attachment aperture 620a and a second attachment aperture 620b (as shown in FIG. 20) of fifth carrying arm segment 608a and sixth carrying arm segment 608b. In certain embodiments, first attachment aperture 620a and second attachment aperture 620b are (respectively) configured to secure a portion of first attachment means 612a and second attachment means 612b such that first attachment means 612a and second attachment means 612b may hang or extend vertically from fifth carrying arm segment 608a and sixth carrying arm segment 608b (respectively). In certain embodiments, first attachment means 612a and second attachment means 612b may comprise a loop portion configured to receive a clip, cord, rope, carabiner, and/or other attachment means. In accordance with certain aspects of the present disclosure, a user may connect a first cargo load to first attachment means 612a and/or a second cargo load to second attachment means 612b such that the user may carry the first cargo load and/or the second cargo load via apparatus 600 by balancing the shoulder rest portion 614 of central portion 602 on the user's shoulder.

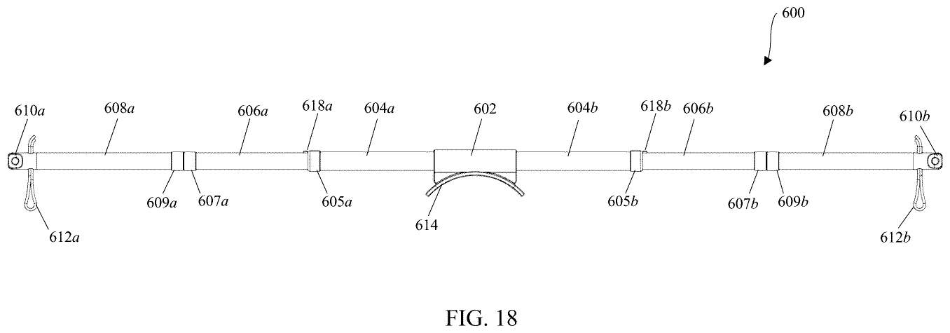

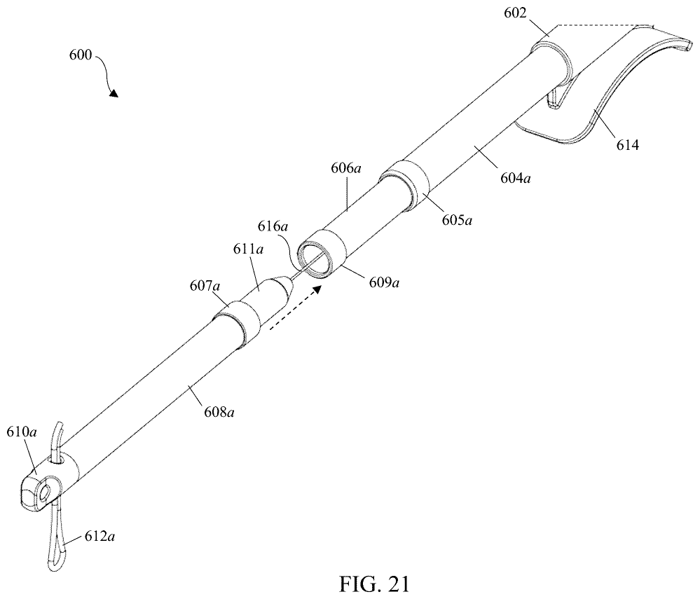

In accordance with certain aspects of the present disclosure, apparatus 600 may be selectively configured in an extended configuration for use (e.g., as shown in FIGS. 17-18) or a collapsed configuration when not in use (e.g., as shown in FIGS. 19-20). As shown in FIGS. 19-20, fifth carrying arm segment 608a may comprise a first protrusion 611a and sixth carrying arm segment 608b may comprise a second protrusion 611b. In accordance with certain aspects of the present disclosure, first protrusion 611a may be inserted into a receiving area of third carrying arm segment 606a (e.g., as illustrated in FIG. 21) such that third collar portion 609a is interfaced with first collar portion 607a (e.g., as shown in FIG. 18). Likewise, second protrusion 611b may be inserted into a receiving area of fourth carrying arm segment 606b such that fourth collar portion 609b is interfaced with second collar portion 607b (e.g., as shown in FIG. 18). In accordance with certain aspects of the present disclosure, first protrusion 611a and second protrusion 611b are configured to increase the structural stability and tensile strength of apparatus 600 when apparatus 600 is configured in the extended configuration.

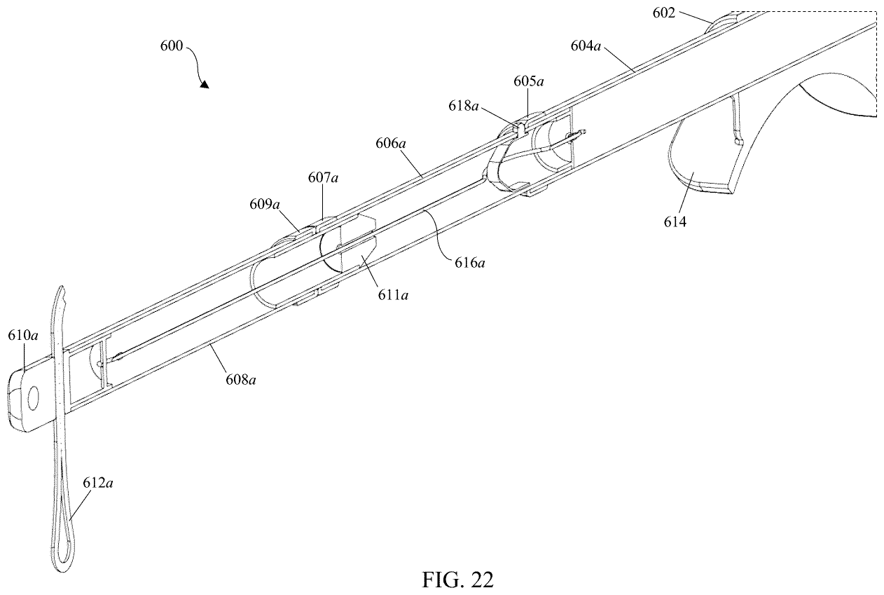

As shown in FIG. 19, apparatus 600 may further comprise a first support wire 616a and a second support wire 616b. In certain embodiments (e.g., as shown in FIG. 22), first support wire 616a may extend through an interior area of each of first carrying arm segment 604a, third carrying arm segment 606a, and fifth carrying arm segment 608a. As shown in FIG. 22, a first end of first support wire 616a may be coupled to an interior surface of first carrying arm segment 604a and a second end of first support wire 616a may be coupled to an interior surface of fifth carrying arm segment 608a. In said embodiments, second support wire 616b may extend through an interior area of each of second carrying arm segment 604b, fourth carrying arm segment 606b, and sixth carrying arm segment 608b. Likewise, a first end of second support wire 616b may be coupled to an interior surface of second carrying arm segment 604b and a second end of second support wire 616b may be coupled to an interior surface of sixth carrying arm segment 608b. In accordance with certain aspects of the present disclosure, first support wire 616a may provide additional tensile strength to first carrying arm segment 604a, third carrying arm segment 606a, and fifth carrying arm segment 608a when apparatus 600 is configured in the extended position, and first support wire 616a may retain fifth carrying arm segment 608a to first carrying arm segment 604a when apparatus 600 is configured in the collapsed configuration. Likewise, second support wire 616b may provide additional tensile strength to second carrying arm segment 604b, fourth carrying arm segment 606b, and sixth carrying arm segment 608b when apparatus 600 is configured in the extended position, and second support wire 616b may retain sixth carrying arm segment 608b to second carrying arm segment 604b when apparatus 600 is configured in the collapsed configuration.

In accordance with certain embodiments (e.g., as shown in FIGS. 18 and 22), apparatus 600 may comprise a first metal tab 618a and a second metal tab 618b. As shown in FIG. 22, first metal tab 618a may comprise a bent portion with a button disposed on a first (i.e., upper) end of the bent portion. First metal tab 618a may be housed in an interior area of third carrying arm segment 606a. First metal tab 618a may be configured to apply outward pressure to the interior area of third carrying arm segment 606a; e.g., such that the button is upwardly biased against an upper surface of the interior area of third carrying arm segment 606a. As shown in FIG. 22, third carrying arm segment 606a comprises at least one aperture disposed on an upper surface of third carrying arm segment 606a. In accordance with said embodiments, the button of first metal tab 618a may extend through the aperture of third carrying arm segment 606a when third carrying arm segment 606a is positioned such that the aperture is aligned with the button of first metal tab 618a. In accordance with said embodiments, first metal tab 618a is configured to retain third carrying arm segment 606a in a fixed position when the button of first metal tab 618a is interfaced with the aperture of third carrying arm segment 606a. To selectively disengage said interface, the user may depress the button while sliding third carrying arm segment 606a inwardly to disconnect first metal tab 618a from third carrying arm segment 606a. In accordance with the certain aspects of the present disclosure, second metal tab 618b may be operably engaged with fourth carrying arm segment 606b to retain fourth carrying arm segment 606b in a fixed position in the same manner as described in the foregoing description of first metal tab 618a and third carrying arm segment 606a.

The terminology used herein is for describing particular embodiments only and is not intended to be limiting of the embodiments. As used herein, the singular forms “a,” “an,” and “the” are intended to include the plural forms as well, unless the context clearly indicates otherwise. It will be further understood that the terms “comprises,” “comprising,” “includes,” and/or “including,”, and variants thereof, when used herein, specify the presence of stated features, steps, operations, elements, and/or components, but do not preclude the presence or addition of one or more other features, steps, operations, elements, components, and/or groups thereof. As used herein, “exemplary” means serving as an example or illustration and does not necessarily denote ideal or best.

It will be understood that when an element is referred to as being “coupled,” “connected,” or “responsive” to another element, it can be directly coupled, connected, or responsive to the other element, or intervening elements may also be present. In contrast, when an element is referred to as being “directly coupled,” “directly connected,” or “directly responsive” to another element, there are no intervening elements present. As used herein, the term “and/or” includes any and all combinations of one or more of the associated listed items.

Spatially relative terms, such as “above,” “below,” “upper,” “lower,” “top, “bottom,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly. Well-known functions or constructions may not be described in detail for brevity and/or clarity.

It will be understood that, although the terms “first,” “second,” etc. may be used herein to describe various elements, these elements should not be limited by these terms. These terms are only used to distinguish one element from another. Thus, a first element could be termed a second element without departing from the teachings of the present embodiments. Unless otherwise defined, all terms (including technical and scientific terms) used herein have the same meaning as commonly understood by one of ordinary skill in the art to which these embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Where a range of values is provided, it is understood that each intervening value, to the tenth of the unit of the lower limit unless the context clearly dictates otherwise, between the upper and lower limit of that range and any other stated or intervening value in that stated range is encompassed by the invention. The upper and lower limits of these smaller ranges may independently be included in the smaller ranges, and are also encompassed by the invention, subject to any specifically excluded limit in a stated range. Where a stated range includes one or both of the endpoint limits, ranges excluding either or both of those included endpoints are also included in the scope of the invention.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

The present disclosure includes that contained in the appended claims as well as that of the foregoing description. Although this invention has been described in its exemplary forms with a certain degree of particularity, it is understood that the present disclosure of has been made only by way of example and numerous changes in the details of construction and combination and arrangement of parts may be employed without departing from the spirit and scope of the invention. Therefore, it will be apparent to those skilled in the art that various modifications and variations can be made to the disclosed embodiments without departing from the scope or spirit of the invention. In view of the foregoing, it is intended that the invention covers modifications and variations of this disclosure within the scope of the following claims and their equivalents.

What is claimed is:

1. A portable carrying apparatus comprising:
an elongated body portion comprising a first end and a second end and a hollow interior portion;
a first arm portion coupled to the first end of the elongated body portion, wherein the first arm portion is slidably interfaced with the hollow interior portion of the elongated body portion;
a second arm portion coupled to the second end of the elongated body portion, wherein the second arm portion is slidably interfaced with the hollow interior portion of the elongated body portion;
a first attachment means coupled to a distal end of the first arm portion, wherein the first attachment means is configured to receive a first cargo load; and
a second attachment means coupled to a distal end of the second arm portion, wherein the second attachment means is configured to receive a second cargo load,
wherein the first arm portion and the second arm portion are configured to be selectively extended or retracted from the hollow interior portion.

2. The portable carrying apparatus of claim 1 further comprising a first reducer housing coupled to the first end of the elongated body portion, wherein the first reducer housing is slidably interfaced with the first arm portion.

3. The portable carrying apparatus of claim 2 further comprising a second reducer housing coupled to the second end of the elongated body portion, wherein the second reducer housing is slidably interfaced with the second arm portion.

4. The portable carrying apparatus of claim 1 further comprising a first locking means configured to be interfaced with the first arm portion to selectively secure the first arm portion at a fixed position.

5. The portable carrying apparatus of claim 4 further comprising a second locking means configured to be interfaced with the second arm portion to selectively secure the second arm portion at a fixed position.

6. The portable carrying apparatus of claim 1 wherein the first attachment means or the second attachment means comprises a loop portion.

7. The portable carrying apparatus of claim 4 wherein the first arm portion comprises one or more apertures disposed on a surface of the first arm portion, wherein the first locking means is configured to be interfaced with the one or more apertures to selectively secure the first arm portion at the fixed position.

8. The portable carrying apparatus of claim 5 wherein the second arm portion comprises one or more apertures disposed on a surface of the second arm portion, wherein the second locking means is configured to be interfaced with the one or more apertures to selectively secure the second arm portion at the fixed position.

9. The portable carrying apparatus of claim 1 wherein the first arm portion and the second arm portion are configured to be independently positioned to adjust a center of gravity of the elongated body portion.

10. A portable carrying apparatus comprising:
a body portion comprising a curved central portion and a first connector portion extending from a first side of the curved central portion and a second connector portion extending from a second side of the curved central portion;
a first arm portion comprising a proximal end and a distal end, wherein the proximal end of the first arm portion is configured to be selectively interfaced with the first connector portion to securely couple the first arm portion to the body portion;
a second arm portion comprising a proximal end and a distal end, wherein the proximal end of the second arm portion is configured to be selectively interfaced with the second connector portion to securely couple the second elongated arm portion to the body portion;
a first attachment means coupled to the distal end of the first arm portion, wherein the first attachment means is configured to receive a first cargo load; and
a second attachment means coupled to the distal end of the second arm portion, wherein the second attachment means is configured to receive a second cargo load,
wherein the first arm portion and the second arm portion are configured to be selectively disconnected from the body portion.

11. The portable carrying apparatus of claim 10 wherein the first attachment means or the second attachment means comprises a loop portion.

12. The portable carrying apparatus of claim 10 wherein the first attachment means or the second attachment means comprises a grommet portion.

13. The portable carrying apparatus of claim 10 wherein the first arm portion and the second arm portion each comprise an elongated tube.

14. The portable carrying apparatus of claim 10 wherein the first connector portion and the second connector portion each comprise a threaded interface.

15. The portable carrying apparatus of claim 10 wherein the curved central portion of the body portion is configured to be interfaced with a user's shoulder.

16. The portable carrying apparatus of claim 10 wherein the first arm portion comprises at least one aperture configured to receive a cord or rope therethrough.

17. The portable carrying apparatus of claim 10 wherein the second arm portion comprises at least one aperture configured to receive a cord or rope therethrough.

18. The portable carrying apparatus of claim 10 wherein the body portion comprises a first load reinforcing portion disposed on the first side of the curved central portion.

19. The portable carrying apparatus of claim 18 wherein the body portion comprises a second load reinforcing portion disposed on the second side of the curved central portion.

20. A portable carrying apparatus comprising:
a body portion comprising a first end and a second end and a hollow interior portion;
a first reducer housing coupled to the first end of the body portion;
a second reducer housing coupled to the second end of the body portion;
a first carrying arm slidably interfaced with the first reducer housing, wherein the first carrying arm is configured to be selectively extended or retracted from the hollow interior portion of the body portion; and
a second carrying arm slidably interfaced with the second reducer housing, wherein the second carrying arm is configured to be selectively extended or retracted from the hollow interior portion of the body portion,
wherein the first carrying arm is configured to carry a first cargo load and the second carrying arm is configured to carry a second cargo load.
